(19) United States
(12) Patent Application Publication
(10) Pub. No.: US 2025/0132626 A1
(43) Pub. Date: Apr. 24, 2025

(54) MOTOR

(71) Applicant: LG INNOTEK CO., LTD., Seoul (KR)

(72) Inventor: Ja Young SEO, Seoul (KR)

(73) Assignee: LG INNOTEK CO., LTD., Seoul (KR)

(21) Appl. No.: 18/719,193

(22) PCT Filed: Jan. 12, 2023
(86) PCT No.: PCT/KR2023/000555

§ 371 Date: Jun. 12, 2024

(30) Foreign Application Priority Data
Jan. 13, 2022 (KR) 10-2022-0005001

(51) Int. Cl. H02K 3/50

(52) U.S. Cl. CPC H02K 3/50; H02K 2203/09

(57) ABSTRACT

The present invention may provide a motor comprising: a shaft; a rotor coupled to the shaft; a stator disposed to correspond to the rotor, the stator comprising a stator core, an insulator coupled to the stator core, and a coil disposed on the insulator; a bus bar electrically connected to the coil; and a bus bar holder supporting the bus bar, wherein the bus bar includes a bus bar body connected to the coil and an extension part bent from the bus bar body, the extension part includes a first part connected to the bus bar body and a second part extended from the first part, the bus bar holder includes a first hole and a second hole communicating with the first hole and having a shape that is different from that of the first hole, the shape of the cross section of the first part and the shape of the cross section of the second part are different from each other, the first part is disposed in the first hole, a portion of the second part is disposed in the second hole, and the rest of the second part is exposed to the outside of the bus bar holder.

### TECHNICAL FIELD

Embodiments relate to a motor.

### BACKGROUND ART

Generally, a rotor of a motor is rotated by electromagnetic interaction between the rotor and a stator. In this case, a shaft connected to the rotor also rotates to generate a rotational driving force.

The rotor and the stator are accommodated in a housing. The housing is a cylindrical hollow member.

The stator may include a stator core and a coil wound around the stator core. The coil may be connected to a bus bar. The bus bar is supported by a bus bar holder. Three bus bars: U-phase, V-phase, and W-phase bus bars may be provided. The bus bar holder may be a mold surrounding the bus bar.

An end portion of one side of the bus bar may be connected to the coil, and an end portion of the other side of the bus bar may be connected to an external device. The bus bar may generally have a quadrangular cross section in consideration of fusing with a coil having a circular cross section. Therefore, when a terminal of the external device is not bar-shaped terminal, a separate bus bar having a cross-sectional shape corresponding to that of the terminal of the external device should be additionally connected to the bus bar connected to the coil.

To additionally connect the bus bar as described above, there is a problem that the manufacturing process becomes complicated and the manufacturing cost increases.

### DISCLOSURE

### Technical Problem

Therefore, embodiments are directed to providing the above problem and to providing a motor capable of reducing the number of manufacturing processes by connecting a coil with an external device using a single bus bar even when a terminal of the external device is not a bar type terminal.

The object of the present invention is not limited to the above-described object, and other objects that are not mentioned will be able to be clearly understood by those skilled in the art from the following description.

### Technical Solution

An embodiment may provide a motor including a shaft, a rotor coupled to the shaft, a stator disposed to correspond to the rotor, wherein the stator includes a stator core, an insulator coupled to the stator core, and a coil disposed on the insulator, a bus bar electrically connected to the coil, and a bus bar holder configured to support the bus bar, wherein the bus bar includes a bus bar body connected to the coil, and an extension part bent at the bus bar body, the extension part includes a first part connected to the bus bar body, and a second part extending from the first part, the bus bar holder includes a first hole, and a second hole communicating with the first hole and having a different shape from the first hole, a cross-sectional shape of the first part differs from a cross-sectional shape of the second part, and the first part is disposed in the first hole, a portion of the second hole is disposed in the second hole, and the remainder of the second part is exposed to the outside of the bus bar holder.

An embodiment may provide a motor including a shaft, a rotor coupled to the shaft, a stator disposed to correspond to the rotor, wherein the stator includes a stator core, an insulator coupled to the stator core, and a coil disposed on the insulator, a bus bar electrically connected to the coil, and a bus bar holder configured to support the bus bar,
wherein the bus bar includes a first terminal and a second terminal connected to each other, the first terminal protrudes more than one surface of the bus bar holder and is exposed to the outside, the second terminal protrudes more than a side surface of the bus bar holder and is exposed to the outside, and a cross-sectional shape of the first terminal differs from a cross-sectional shape of the second terminal.

### Advantageous Effects

According to the embodiments, it is possible to reduce the number of the manufacturing processes by forming the shape of the end portion of the bus bar connected to the coil and the shape of the end portion of the bus bar connected to the terminal of the external device that differ from each other to be connected to the terminal of the external device using the single bus bar without connecting two types of bus bars.

According to the embodiments, it is possible to reduce the number of components through the bus bar having the end portion with the shape differing from that of the end portion of the bar type bus bar connected to the coil.

According to the embodiments, it is possible to increase the fixing force of the bus bar in the bus bar holder by forming a portion of the bus bar connected to the terminal of the external device in the rounded bar and forming a portion of the bus bar located inside the bus bar holder in the quadrangular cross section.

### DESCRIPTION OF DRAWINGS

FIG. 1 is a view showing a motor according to an embodiment.

FIG. 2 is a view showing a bus bar and a bus bar holder.

FIG. 3 is a view showing any one of the bus bars.

FIG. 4 is a view showing another one of the bus bars.

FIG. 5 is a view showing another one of the bus bars.

FIG. 6 is an enlarged view of an extension part of the bus bar.

FIG. 7 is a side view of the extension part of the bus bar.

FIG. 8 is a plan view of the extension part of the bus bar.

FIG. 9 is a side cross-sectional view of the bus bar and the bus bar holder along line A-A in FIG. 1.

### MODE FOR INVENTION

A direction parallel to a longitudinal direction (vertical direction) of a shaft is referred to as an axial direction, a direction perpendicular to the axial direction about the shaft is referred to as a radial direction, and a direction along a circle having a radius in the radial direction around the shaft is referred to as a circumferential direction.

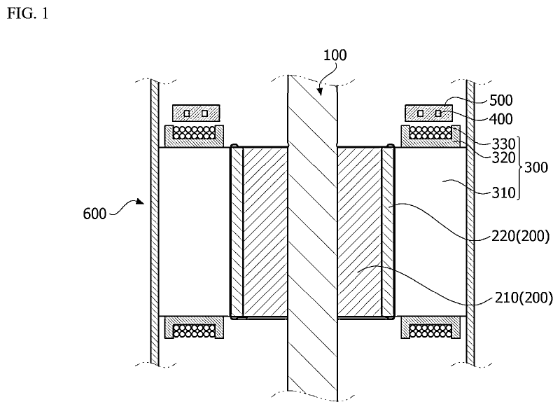

FIG. 1 is a view showing a motor according to an embodiment.

Referring to FIG. 1, the motor according to the embodiment may include a shaft 100, a rotor 200, a stator 300, a bus bar 400, a bus bar holder 500, and a housing 600. Hereinafter, the inside indicates a direction from the housing 600 toward the shaft 100, which is the center of the motor, and the outside indicates a direction opposite to the inside, which is a direction from the shaft 100 to the housing 600. In addition, a radial direction below is a direction with respect to the axial center of the shaft 100.

The shaft 100 may be coupled to the rotor 200. When electromagnetic interaction occurs between the rotor 200 and the stator 300 through current supply, the rotor 200 rotates, and the shaft 100 rotates in conjunction with the rotation of the rotor 200.

The rotor 200 is rotated by the electrical interaction with the stator 300. The rotor 200 may be disposed inside the stator 300.

The stator 300 is disposed outside the rotor 200. The stator 300 may include a stator core 310, an insulator 320 mounted on the stator core 310, and a coil 330. The coil 330 may be wound around the insulator 320. The insulator 320 is disposed between the coil 330 and the stator core 310 and serves to electrically insulate the stator core 310 and the coil 330. The coil 330 causes the electrical interaction with a magnet of the rotor 200.

The bus bar 400 may be disposed on the stator. The bus bar 400 is electrically connected to the coil. In addition, the bus bar 400 may be connected to an external power source.

The bus bar holder 500 supports the bus bar 400. The bus bar holder 500 may be an annular member including the bus bar 400 therein.

The stator 300 and the rotor 200 are disposed inside the housing 600.

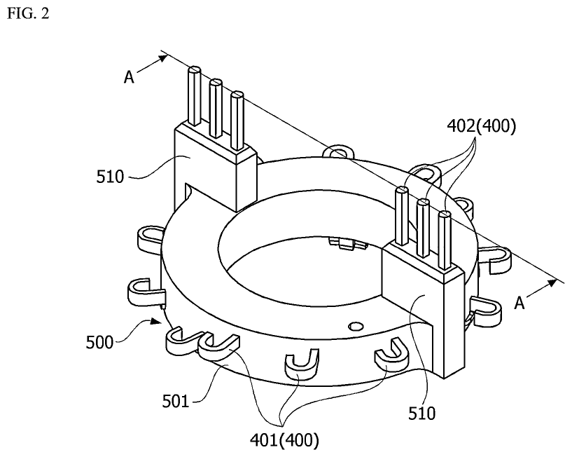

FIG. 2 is a view showing the bus bar 400 and the bus bar holder 500.

Referring to FIG. 2, the bus bar 400 has an end portion of one side connected to the coil 330 and the end portion of the other side connected to the external device. A plurality of the bus bars 400 may be disposed.

The bus bar holder 500 may include an annular holder body 501 and a boss 510. The boss 510 may protrude from one surface of the holder body 501. The boss 510 serves to support the end portion of the bus bar 400 disposed to extend in an axial direction to be connected to the external device.

Hereinafter, the end portion of the bus bar 400 protruding upward from the boss 510 to be connected to the external device is referred to as a first terminal 401, and an end portion of the bus bar 400 protruding outward from an outer surface of the holder body 501 to be connected to the coil is referred to as a second terminal 402.

A cross-sectional shape of the first terminal 401 differs from a cross-sectional shape of the second terminal 402. As an example, the first terminal 401 may have a quadrangular cross section for fusing with a coil having a circular cross section. In addition, the second terminal 402 may have a circular cross section corresponding to a shape of a terminal of the external device.

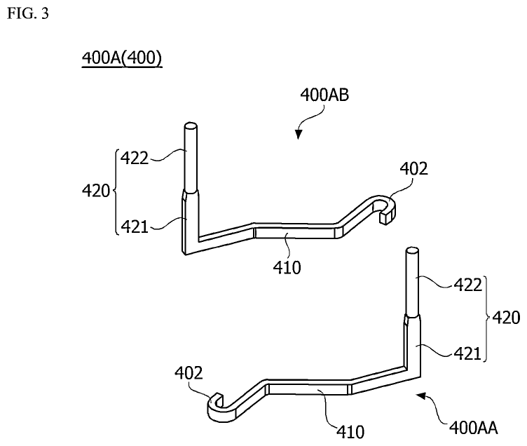

FIG. 3 is a view showing any one of the bus bar 400.

Referring to FIG. 3, a bus bar 400A may include a bus bar body 410 and an extension part 420 bent at the bus bar body 410. The hook type second terminal 402 is disposed on the end portion of the bus bar body 410. The extension part 420 may be disposed perpendicular to the bus bar body 410. Any one of the three bus bars 400 may have a plurality of bending areas disposed on the bus bar body 410.

A pair of bus bars 400 having the same shape may be disposed. The pair of bus bars 400 may be electrically separated.

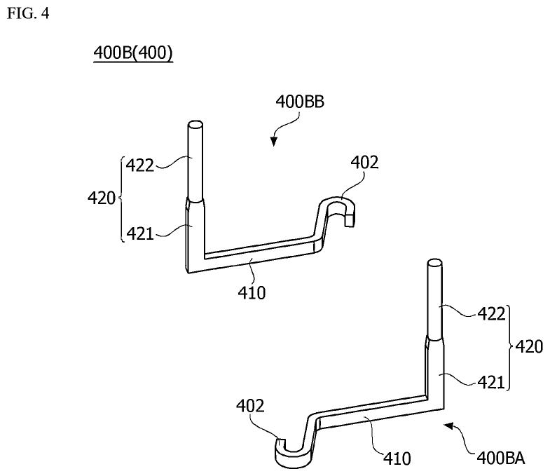

FIG. 4 is a view showing another bus bar 400B among the bus bars 400.

Referring to FIG. 4, another bus bar 400B among the bus bars 400 may also include the bus bar body 410 and the extension part 420 bent at the bus bar body 410. No bending area may be not present in the bus bar body 410 of the bus bar 400B.

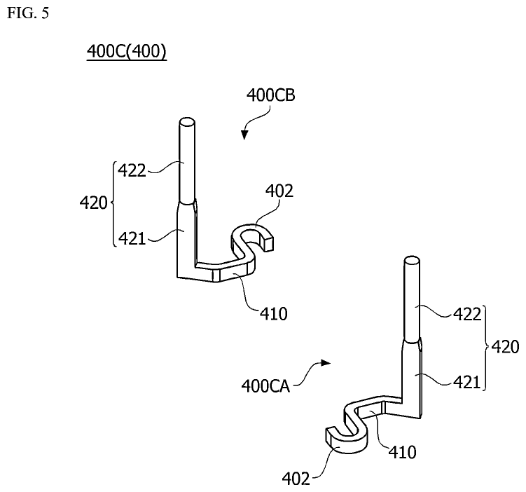

FIG. 5 is a view showing another bus bar 400C among the bus bars 400.

Referring to FIG. 5, another bus bar 400C among the bus bars 400 may include the bus bar body 410 and the extension part 420 bent at the bus bar body 410. One bending area may be present in the bus bar body 410 of the bus bar 400C.

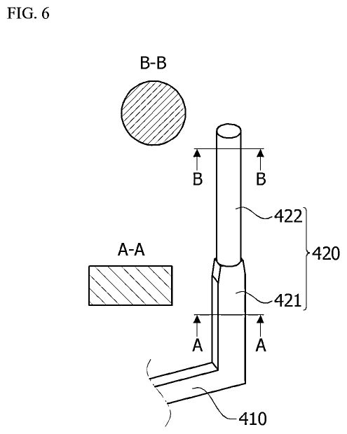

FIG. 6 is an enlarged view of the extension part 420 of the bus bar 400.

Referring to FIG. 6, the extension part 420 may include a first part 421 and a second part 422. The first part 421 is connected to the bus bar body 410. The second part 422 extends from the first part 421. The second part 422 is a part connected to an external device. The first part 421 may have a quadrangular cross-sectional shape, and the second part 422 may have a circular cross-sectional shape corresponding to a shape of the terminal of the external device.

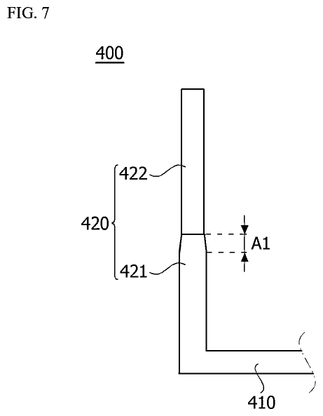

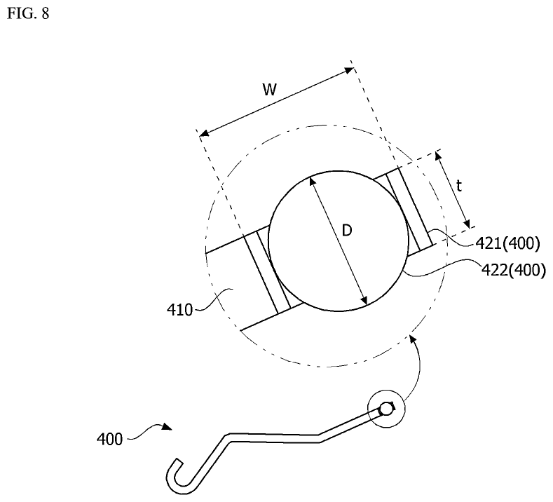

FIG. 7 is a side view of the extension part 420 of the bus bar 400, and FIG. 8 is a plan view of the extension part 420 of the bus bar 400.

Referring to FIGS. 7 and 8, the extension part 420 may include a first area A1. The first area A1 is a portion of the first part 421 and corresponds to an area whose cross sectional size decreases toward an end of the first part 421.

Referring to FIG. 8, a cross sectional diameter D of the second part 422 may be greater than a thickness t of the first part 421 and may be smaller than a width W of the first part 421. A portion of the second part 422 may protrude from an outer surface of the first part 421. The cross sectional sizes of the first part 421 and the bus bar body 410 may be set constant according to design values, and the cross sectional size of the second part 422 is post-processed to correspond to the size of the terminal of the external device to variously set dimensions under the conditions that the cross sectional diameter D of the second part 422 is greater than the thickness t of the first part 421 and smaller than the width W of the first part 421.

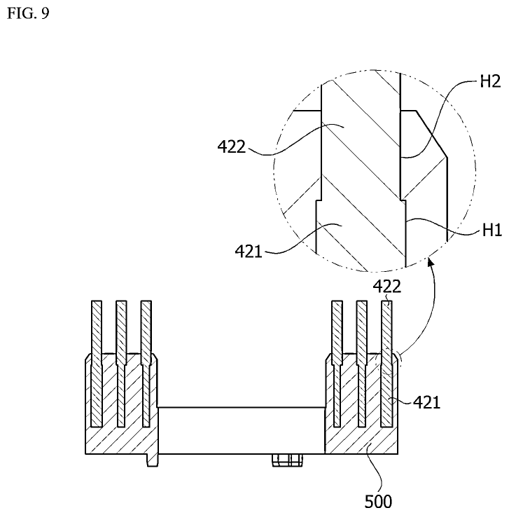

FIG. 9 is a side cross-sectional view of the bus bar 400 and the bus bar holder 500 along line A-A in FIG. 1.

Referring to FIG. 9, the bus bar holder 500 includes a first hole H1 and a second hole H2. The first hole H1 and the second hole H2 may be disposed inside the boss 510 of the bus bar holder 500. A shape of the first hole H1 differs from a shape of the second hole H2. A planar shape of the first hole H1 may be a quadrangle, and a planar shape of the second hole H2 may be a circle. The first part 421 of the bus bar 400 is disposed in the first hole H1, and a portion of the second part 422 of the bus bar 400 is disposed in the second hole H2.

As described above, the second part 422 of the bus bar 400 connected to terminals of some devices is formed of a rounded bar, and the first part 421 of the bus bar 400 located inside the bus bar holder 500 is formed to have a cross-sectional quadrangular shape, thereby increasing a fixing force of the bus bar 400 in the bus bar holder 500.

The above-described embodiments may be used in various devices such as devices for a vehicle or home appliance.

1. A motor comprising:
a shaft;
a rotor coupled to the shaft;
a stator disposed to correspond to the rotor,
wherein the stator includes a stator core, an insulator coupled to the stator core, and a coil disposed on the insulator;
a bus bar electrically connected to the coil; and
a bus bar holder configured to support the bus bar,
wherein the bus bar includes a bus bar body connected to the coil, and an extension part bent at the bus bar body,
the extension part includes a first part connected to the bus bar body, and a second part extending from the first part,
the bus bar holder includes a first hole, and a second hole communicating with the first hole and having a different shape from the first hole,
a cross-sectional shape of the first part differs from a cross-sectional shape of the second part, and
the first part is disposed in the first hole, a portion of the second hole is disposed in the second hole, and the remainder of the second part is exposed to the outside of the bus bar holder.

2. The motor of claim 1, wherein the first part has a circular cross section, and the first part has a quadrangular cross section.

3. The motor of claim 1, wherein the first part includes a first area whose size of a cross section decreases toward an end thereof, and
the first area is connected to the second part.

4. The motor of claim 1, wherein at least a portion of an outer surface of the second part protrudes more than an outer surface of the first part.

5. The motor of claim 1, wherein a diameter of the cross section of the second part is greater than a thickness of the first part and smaller than a width of the first part.

6. The motor of claim 1, wherein the bus bar holder includes a boss protruding from one surface of the bus bar holder, and
the first hole and the second hole are each disposed in the boss.

7. A motor comprising:
a shaft;
a rotor coupled to the shaft;
a stator disposed to correspond to the rotor,
wherein the stator includes a stator core, an insulator coupled to the stator core, and a coil disposed on the insulator;
a bus bar electrically connected to the coil; and
a bus bar holder configured to support the bus bar,
wherein the bus bar includes a first terminal and a second terminal connected to each other,
the first terminal protrudes more than one surface of the bus bar holder and is exposed to the outside,
the second terminal protrudes more than a side surface of the bus bar holder and is exposed to the outside, and
a cross-sectional shape of the first terminal differs from a cross-sectional shape of the second terminal.

8. The motor of claim 7, wherein the bus bar holder includes a boss protruding from one surface of the bus bar holder, and
the second terminal is exposed upward from an upper surface of the boss.

9. The motor of claim 7. wherein the first terminal has a planar cross section. and the second terminal has a curved cross section.

10. The motor of claim 9. wherein a planar surface of the first terminal is a quadrangle. and the second terminal has a circular cross section.
